(19) United States
(12) Patent Application Publication
(10) Pub. No.: US 2016/0106090 A1
(43) Pub. Date: Apr. 21, 2016

(54) DECOY

(71) Applicant: Kevin Rhett Young, Brandon, MS (US)

(72) Inventor: Kevin Rhett Young, Brandon, MS (US)

(21) Appl. No.: 14/516,087

(22) Filed: Oct. 16, 2014

(51) Int. Cl. A01M 31/06

(52) U.S. Cl. CPC A01M 31/06

(57) ABSTRACT

There is disclosed an animal decoy (10) including a hollow base (11) and a cover (12) removably coupled to the base. The base has a lower portion or shell (14) releasably coupled together through latches (28) to define a storage space within the decoy. The cover is made of a flexible material which includes an iridescent cloth material portion. The base shells may be nestable to minimize storage space necessary for the decoys. The lower shell may also be replaced by another lower shell (60) of a different stance or configuration.

### TECHNICAL FIELD

This invention relates generally to a animal decoys, and more specifically to animal decoys having a removable cover and advantageous storage characteristics.

### BACKGROUND OF INVENTION

Animal decoys have been used by people for thousands of years. These decoys may be utilized to attract game as well as repel game from a select area. One of the most popular types of animal decoys is the water fowl decoy, which may be in the form of different varieties of ducks or geese.

Water fowl decoys have typically been made of solid wood which is shaped in the form of the fowl and painted to resemble the fowl's markings. More recently water fowl decoys have been made of a hollow unitary plastic form which is colored or painted to resemble the fowl's markings.

One problem with today's decoys is that they are colored or painted to resemble one species or gender of duck or goose. As such, a hunter must purchase and store a variety of decoys to attract different species. Additionally, the paint or coloring may fade over time, requiring them to be repainted or discarded.

Another problem is that the decoys are typically designed to be either a water deployed decoy for use on the water or a land deployed decoy for use on land. Again, this limitation requires that the hunter have a variety of decoys for use in both types of environments. An additional problem with water deployed decoys is that they must be tethered to an anchor to prevent them from drifting. The tether must be manually gathered and stored when not in use, a task which is time consuming, tedious and painful in cold conditions.

Accordingly, it is seen that a need remains for a decoy that may be easily changed in appearance, that may be used in both water and land environments, and which may be easily tethered. It is to the provision of such therefore that the present invention is primarily directed.

### SUMMARY OF THE INVENTION

In a preferred form of the invention an animal decoy comprises a base having a first shell portion and a second shell portion releasably coupled to the first shell portion. The first shell portion and the second shell portion defining a storage area within the base. The animal decoy also having a latch for releasably coupling the first shell portion to the second shell portion.

In another preferred form of the invention comprises a base, and a cover configured to overlay the base. The cover has at least a portion made of an iridescent cloth material.

### BRIEF DESCRIPTION OF DRAWINGS

FIG. 1 is a perspective view of a decoy embodying principles of the invention in a preferred form.

FIG. 2 is a cross-sectional side view of the decoy of FIG. 1.

FIG. 3 is an exploded perspective view of the decoy of FIG. 1, shown with an additional lower portion.

FIG. 4 is a cross-sectional side view of the decoy of FIG. 1 shown in a stowed configuration.

### DETAILED DESCRIPTION

With reference next to the drawings, there is shown an animal decoy 10 in a preferred form of the present invention. The animal decoy 10 is shown in the form of a duck, however, it should be understood that any animal may be replicated or depicted.

The decoy 10 includes a base 11 and a cover 12 removably coupled to the base 11. The base 11 is made of a plastic material or the like and is of a hollow construction with a lower portion or shell 14 releasably coupled to an upper portion or shell 15. A resilient sealing gasket 17, made of rubber or the like, is positioned between the lower shell 14 and upper shell 15 to prevent the intrusion of water therebetween. The base 11 includes a body 19 and a head 20 extending from the body 19, however, preferably the base does not include details associated with any particular species or gender of the animal, such as tail feathering appearance, head shape, wing shape, etc.

The lower shell 14 includes a weight or ballast 21 along the bottom side 22 which maintains the decoy in a generally upright orientation. The lower shell 14 also include a weight line tube 24 which extends from a bottom opening 25 in the bottom of the decoy to a top opening 26 which is well above the waterline of the decoy when it is deployed in water. The lower shell 14 also includes two spring biased pushbutton type latches 28 positioned along the top of the lower portion which include an outwardly extending pushbutton 29. It should be understood that other types of latches may also be utilized to releasably couple the shells together.

The upper portion 15 includes an anchor line reel 30 removably coupled to the interior top surface 32 through a bracket 33. The reel 30 may be a spring assisted reel which automatically winds or retracts an anchor line 31, much in the manner of a conventional tape measure, or a manually driven reel. In the event that the reel 30 is of the manually driven type, the reel 30 includes a drive socket 35 extending through the upper shell 15 into which a handle 36 or motorized device such as a drill may be inserted to rotate the reel and thereby retract the anchor line. A drive hole 38 in the upper shell 15 is aligned with the drive socket 35 to allow access thereto without separating the shells 14 and 15. An anchor or weight 39 is coupled to the anchor line 31 opposite the reel 30. The upper shell 15 includes two oppositely disposed latch holes or openings 41 which are alignable with the pushbuttons 29 of latches 28 to maintain the upper shell 15 coupled to the lower shell 14 in a releasable fashion. A pliable or flexible cup-shaped seal 42 may be mounted to the upper shell so that the pushbutton resides within the cup-shaped seal to prevent water from entering the latch holes 41.

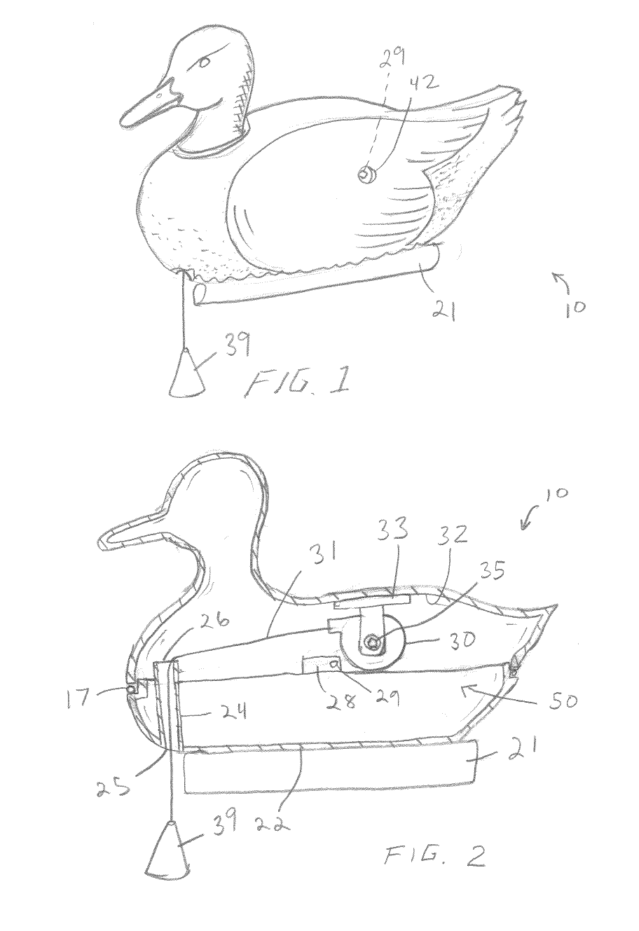

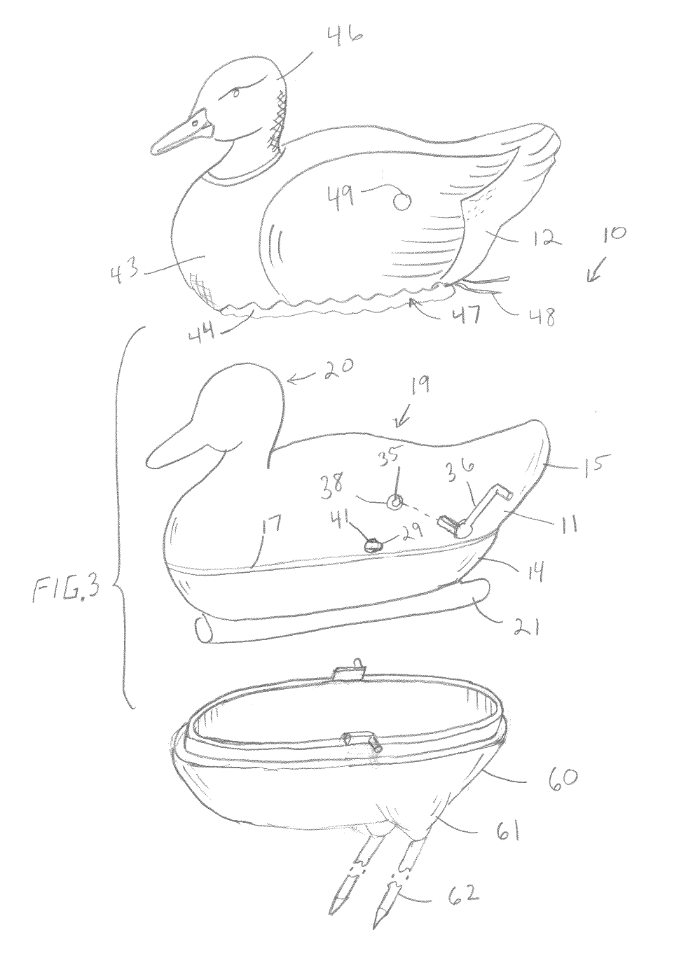

The cover 12 is made of a flexible material such as a fabric or cloth. The cover has an exterior surface 43 and an interior surface 44. The exterior surface 43 has a pattern thereon that is indicative of a select species and gender of the animal portrayed. Preferably, the cover may include select portions that are made of an iridescent cloth material such as velvet or velveteen, which may be made of a silk, wool, cotton or blend of such materials. In the example shown in FIG. 1, the decoy cover is intended to replicate the colorings or markings of a male mallard duck. As such, the covering portion representing the head 46 is made of a dark green iridescent cloth material. The iridescent cloth material best simulates the color and appearance associated with certain feathering patterns associated with such water fowl. The iridescent cloth material may be utilized on other portions of the cover 12, such as areas associated with the wing, the tail feathers, or neck area.

The cover 12 is generally in the same form or shape as the base 11. The cover 12 includes a bottom opening 47 which has a drawstring or elastic member 48 to gather the bottom opening 47 once it is placed over the base. The cover 12 may include a handle opening 49 which is generally aligned with the drive hole 38 of the upper shell 15 so that the drive socket 35 is accessible without having to remove the cover 12 from the base 11.

The base 11 being constructed of two separable shells enables the decoys to be stored in less space, as the lower shell may be inverted and nested within the upper shell so that a majority of the lower shell resides within the confines of the upper shell. Also, the shells may be separated and the interior space of the base used as storage area 50 for the cover 12, tethers, anchors, removable reel 30, or other materials associated with the hunt or in such event that the reel 30 shown in the preferred embodiment is not incorporated. Again, the storage capacity aids in minimizing storage space associated with a hunt.

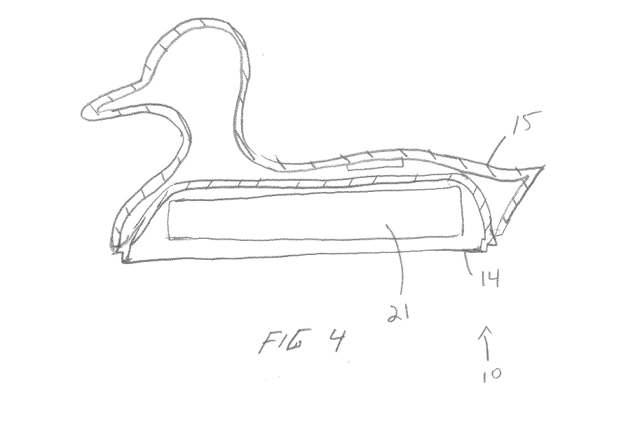

With reference to FIG. 3, there is shown an additional or optional lower shell 60 which may be utilized when hunting on land. Here, the lower shell 60 has legs 61 the lower portion 62 of which includes a pointed spike which may be driven into the ground to maintain the position of the decoy. As such, the single decoy 10 may include one lower shell 14 for use on water and a second lower shell 60 for use on land. Thus, the anatomical stance configuration or action configuration of the lower shell 14 of FIG. 1 is that of a floating duck while the anatomical stance configuration or action configuration of the lower shell 60 shown in the lower portion of FIG. 3 is that of a standing duck. This optional lower shell makes the decoy convertible between water and land use, which again saves the hunter storage space by eliminating the need for storing two different types of decoys. The replacement may also be conducted on the upper shell wherein the first action configuration may be that of a duck at rest while the second action configuration may be that of a duck landing or drying its feathers with its wing's wholly or partially extended.

With reference next to FIG. 4, the lower shell 14 and upper shell 5 may be configured so that the lower shell may be inverted and nested within the interior space of the upper shell, or visa-versa. Here, the ballast 21 may be made to be removable so that it may be positioned within the interior of the lower shell to further compact the entire disassembled structure of the decoy for storage purposes. Additionally, the latch holes 41 and latches 28 may be configured so that the pushbutton 29 resides within the latch hole 41 in the stowed configuration nested within the upper shell, which would prevent the unwanted separation of the two shells during storage and/or transportation.

It should be understood that the decoy 10 may also include removable wing attachments to simulate a bird in flight.

It should be understood that the base 11 is preferably made in the most simple form of the represented animal. In this manner, the cover 12 may include structural elements to refine the shape of the animal to the species. For example, should the decoy be in the form of a duck, the cover may include internal structures to refine the exact shape of the head and tail feathers, as the head and tail feathers of a mallard duck are different from the head and tail feathers of a pintail or wood duck.

It thus is seen that a decoy is now provided which overcomes problems associated with the prior art. While this invention has been described in detail with particular references to the preferred embodiments thereof, it should be understood that many modifications, additions and deletions, in addition to those expressly recited, may be made thereto without departure from the spirit and scope of the invention as set forth in the following claims.

1. An animal decoy comprising,
a base having a first shell portion and a second shell portion releasably coupled to said first shell portion, said first shell portion and said second shell portion defining a storage area within said base,
a latch for releasably coupling said first shell portion to said second shell portion.

2. The animal decoy of claim 1 wherein said first shell portion is configured to be received within said second shell portion in an inverted configuration so that a majority of said first shell portion is contained within the interior of said second shell portion.

3. The animal decoy of claim 1 further comprising a third shell portion configured to replace said first shell portion and having a different anatomical stance configuration than the anatomical stance configuration of the first shell portion.

4. The animal decoy of claim 1 further comprising a cover having animal markings and configured to fit over said base.

5. The animal decoy of claim 1 further comprising an anchor line reel removably mounted to an interior surface of one said shell portion.

6. The animal decoy of claim 4 further comprising an anchor line reel removably mounted to an interior surface of one said shell portion and wherein said anchor line reel includes a handle socket, and wherein said cover includes a handle opening configured to be aligned with said anchor line reel handle socket.

7. The animal decoy of claim 4 wherein said cover includes a portion made of an iridescent cloth material.

8. The animal decoy of claim 7 further comprising a ballast weight removably coupled to said base.

9. An animal decoy comprising,
a base;
a cover configured to overlay said base, said cover having at least a portion made of an iridescent cloth material.

10. The animal decoy of claim 9 wherein said iridescent cloth material is a velvet or velveteen material.

11. The animal decoy of claim 9 wherein said base has a first shell portion and a second shell portion releasably coupled to said first shell portion, said first shell portion and said second shell portion defining a storage area within said base, and a latch for releasably coupling said first shell portion to said second shell portion.

12. The animal decoy of claim 11 wherein said first shell portion is configured to be received within said second shell portion in an inverted configuration so that a majority of said first shell portion is contained within the interior of said second shell portion.

13. The animal decoy of claim 11 further comprising a third shell portion configured to replace said first shell portion and having a different anatomical stance configuration than the anatomical stance configuration of the first shell portion

14. The animal decoy of claim 11 further comprising an anchor line reel removably mounted to an interior surface of one said shell portion.

15. The animal decoy of claim 11 comprising an anchor line reel removably mounted to an interior surface of one said shell portion and wherein said anchor line reel includes a handle socket, wherein said cover includes a handle opening configured to be aligned with said anchor line reel handle socket.

16. An animal decoy comprising,
a base having a first shell portion configured to replicate a first portion of an animal, a second shell portion configured to replicate a second portion of an animal in a first action configuration, and a third shell portion configured to replace said second shell portion and configured to replicate said second portion of an animal in a second action configuration, and
coupling means for releasably coupling said first shell portion to said second shell portion or said first shell portion to said third shell portion.

17. The animal decoy of claim 16 wherein said first shell portion is configured to be received within said second shell portion in an inverted configuration so that a majority of said first shell portion is contained within the interior of said second shell portion.

18. The animal decoy of claim 16 further comprising a cover having animal markings and configured to fit over said base.

19. The animal decoy of claim 18 wherein said cover includes a portion made of an iridescent cloth material.

20. The animal decoy of claim 16 further comprising an anchor line reel removably mounted to an interior surface of one said shell portion and wherein said anchor line reel includes a handle socket.
